(19) United States
(12) Patent Application Publication
(10) Pub. No.: US 2016/0016469 A1
(43) Pub. Date: Jan. 21, 2016

(54) VEHICLE TRAVEL CONTROL APPARATUS

(71) Applicant: TOYOTA JIDOSHA KABUSHIKI KAISHA, Toyota-shi (JP)

(72) Inventor: Hiroshi YAMADA, Nisshin-shi (JP)

(21) Appl. No.: 14/735,439

(22) Filed: Jun. 10, 2015

(30) Foreign Application Priority Data
Jul. 16, 2014 (JP) 2014-146225

(51) Int. Cl. B60K 31/02

(52) U.S. Cl. CPC B60K 31/02; B60Y 2400/60; B60W 2710/083; B60W 2550/142

(57) ABSTRACT

A vehicle travel control apparatus includes: an electric motor that generates a creep torque; a preceding vehicle following control part that performs a preceding vehicle following control for adjusting an inter-vehicle distance between a preceding vehicle and a host vehicle based on a travel state of the preceding vehicle, the preceding vehicle following control being continued until the host vehicle transitions to a stopped state; and a creep torque control part that controls a creep torque control, wherein the creep torque control part retains a target value of the creep torque to be generated by the electric motor at a predetermined value during a period in which the preceding vehicle following control is performed and the host vehicle travels.

### FIELD

The disclosure is related to a vehicle travel control apparatus.

### BACKGROUND

Japanese Laid-open Patent Publication No. 2010-228644 discloses a following travel controller in which a way of controlling deceleration of a host vehicle is changed immediately before the host vehicle is stopped, from a way of decelerating the host vehicle with deceleration that is calculated based on a target inter-vehicle distance according to the host vehicle speed and relative speed such that the host vehicle is safely stopped, to a way of decelerating the host vehicle with increased deceleration that is calculated based on the detected inter-vehicle distance and the detected host vehicle speed such that the host vehicle is stopped at a distance that is obtained by subtracting a target stop distance from the inter-vehicle distance.

In the case of a hybrid vehicle and an electric vehicle, an electric motor can be used to generate a creep torque. In this case, the creep torque can be varied according to a driver demand deceleration (a brake pedal pressing force or a master cylinder pressure, for example). For example, such a configuration can be contemplated in which the creep torque is not generated when the brake pedal is pressed down (i.e., the demand deceleration is great) in a low speed range for the sake of increasing the mileage, while a relatively great creep torque is generated when the brake pedal pressing force is decreased (i.e., the demand deceleration is small) for the sake of preventing the host vehicle from moving down an uphill slope or preventing a delay in a start of the host vehicle when changing the pedal to be pressed from a brake pedal to an accelerator pedal.

Further, recently, with respect to a preceding vehicle following control such as ACC (Active Cruise Control) a whole vehicle speed range type is known in which the preceding vehicle following control is continued at least until the host vehicle transitions to a stopped state. such a configuration can be contemplated in which, during a period in which the preceding vehicle following control of the whole vehicle speed range type is performed, the demand deceleration immediately before a vehicle stops is made smaller in order to improve feeling of deceleration immediately before the vehicle stops.

In the case of the hybrid vehicle or the electric vehicle, during a period in which the preceding vehicle following control is performed for the whole vehicle speed range, the electric motor can be used to generate the creep torque; however, if the creep torque is varied according to the demand deceleration, there may be a problem that feeling of deceleration immediately before the vehicle stops becomes worse. Specifically, for example, during a period in which the preceding vehicle following control of the whole vehicle speed range type is performed, when the demand deceleration is decreased immediately before the vehicle stops, the creep torque is increased accordingly (i.e., the deceleration is decreased), which causes the feeling of deceleration immediately before the vehicle stops to be worse.

Therefore, an object of this disclosure is to provide a vehicle travel control apparatus that can improve feeling of deceleration immediately before a vehicle stops during a period in which a preceding vehicle following control is performed.

### SUMMARY

According to one aspect of the invention, a vehicle travel control apparatus is provided, which includes:

an electric motor that generates a creep torque;

a preceding vehicle following control part that performs a preceding vehicle following control for adjusting an inter-vehicle distance between a preceding vehicle and a host vehicle based on a travel state of the preceding vehicle, the preceding vehicle following control being continued until the host vehicle transitions to a stopped state; and

a creep torque control part that controls a creep torque control, wherein the creep torque control part retains a target value of the creep torque to be generated by the electric motor at a predetermined value during a period in which the preceding vehicle following control is performed and the host vehicle travels.

### BRIEF DESCRIPTION OF DRAWINGS

FIG. 1 is a diagram illustrating a system configuration of a control system including a vehicle travel control apparatus according an embodiment.

FIG. 2 is an example of a flowchart of a process executed by a drive system ECU 31.

FIG. 3 is another example of a flowchart of a process executed by the drive system ECU 31.

FIG. 4 is a diagram explaining a process illustrated in FIG. 3.

### DESCRIPTION OF EMBODIMENTS

In the following, embodiments are described in detail with reference to appended drawings.

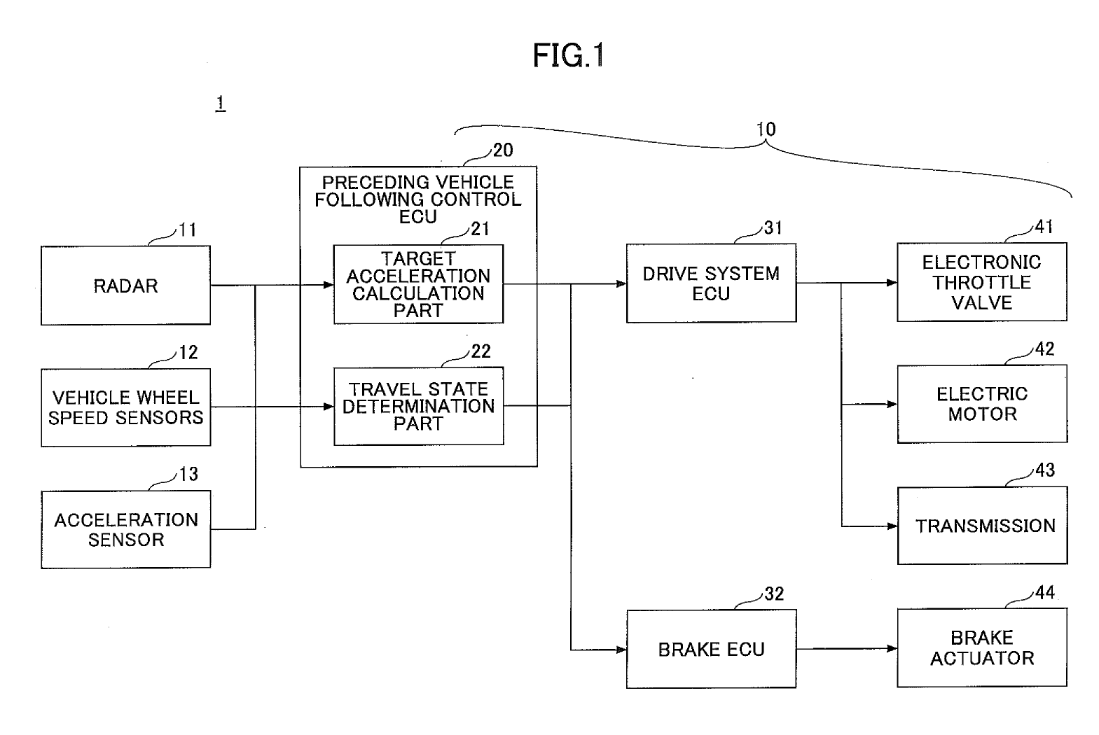

FIG. 1 is a diagram illustrating a configuration of a system 1 that includes a vehicle travel control apparatus 10 according an embodiment. It is noted that connections between elements in FIG. 1 are arbitrary. For example, the connection ways may include a connection via a bus such as a CAN (controller area network), etc., an indirect connection via another ECU, etc., a direct connection, or a connection that enables wireless communication.

The system 1 is installed on the vehicle. In the following, it is assumed that the vehicle is a hybrid vehicle that includes an electric motor 42. However, the vehicle may be an electric vehicle that includes the electric motor 42 without an engine. In the following, unless otherwise specified, the “vehicle” indicates the vehicle (host vehicle) on which the system 1 is installed.

The system 1 includes a radar 11, vehicle wheel speed sensors 12, an acceleration sensor (G sensor) 13, a preceding vehicle following control ECU (Electronic Control Unit) 20, the drive system ECU 31, a brake ECU 32, an electronic throttle valve 41, the electric motor 42, a transmission 43 and a brake actuator 44. It is noted that, in the example illustrated in FIG. 1, the vehicle travel control apparatus 10 includes the preceding vehicle following control ECU 20 (an example of a preceding vehicle following control part), the drive system ECU 31 (an example of a creep torque control part) and the electric motor 42.

The preceding vehicle following control ECU 20 may include a processing device such as a microcomputer. Functions of the preceding vehicle following control ECU 20 (including functions described hereinafter) may be implemented by any hardware, any software, any firmware or any combination thereof.

The preceding vehicle following control ECU 20 is connected to the radar 11. The radar 11 uses a sound wave (a sonic wave, for example), a radio wave (a millimeter wave, for example), a light wave (a laser, for example), etc., to detect preceding vehicle information (a relative distance, a relative speed, etc.) that represents a state of the preceding vehicle. The radar 11 may be a laser radar, a millimeter wave radar, a sonar, etc.

The preceding vehicle following control ECU 20 continues the preceding vehicle following control at least until the vehicle transitions to a stopped state (stationary state). In other words, the preceding vehicle following control ECU 20 continues the preceding vehicle following control until the vehicle speed, becomes 0 or even when the vehicle speed becomes 0. In the following, as an example, the preceding vehicle following control ECU 20 performs the preceding vehicle following control (i.e., the preceding vehicle following control for a whole vehicle speed range) over the whole vehicle speed range including 0 (a stopped state) during a period in which the preceding vehicle is recognized. The preceding vehicle following control is performed to adjust an inter-vehicle parameter (an inter-vehicle distance or an inter-vehicle time) between the preceding vehicle and the host vehicle based on the travel state of the preceding vehicle (i.e., the preceding vehicle information from the radar 11). It is noted that the preceding vehicle following control ECU 20 may perform a constant speed control if the preceding vehicle is not recognized.

An image sensor may be used in addition to or instead of the radar 11. The image sensor includes a camera, which includes imaging elements such as CCDs (charge-coupled device), CMOSs (complementary metal oxide semiconductor), etc., and an image processor to recognize the state of the preceding vehicle. The camera of the image sensor may be of a stereo type. The image sensor detects, based on an image recognition result, the information which represents the state of the preceding vehicle such as the relative speed, position information of the preceding vehicle with respect to the host vehicle, for example, at a predetermined cycle. The position information of the preceding vehicle includes information related to the position (distance) of the preceding vehicle in the back-and-forth direction of the host vehicle, and information related to the lateral position of the preceding vehicle in the lateral direction (width direction). It is noted that the image processing function of the image processor (a function of calculating a position of the preceding vehicle, for example) may be implemented by the preceding vehicle following control ECU 20.

The preceding vehicle following control ECU 20 is connected to the vehicle wheel speed sensors 12 and the acceleration sensor 13. The vehicle wheel speed sensors 12 detect the vehicle speed. The acceleration sensor 13 detects the acceleration according to a road slope angle (gradient).

The preceding vehicle following control ECU 20 is connected to the drive system ECU 31 and the brake ECU 32.

The drive system ECU 31 may include a processing device such as a microcomputer. Functions of the drive system ECU 31 (including functions described hereinafter) may be implemented by any hardware, any software, any firmware or any combination thereof. Further, the drive system ECU 31 may be implemented by a plurality of processing devices (including processing devices in sensors). Further, any part of or all of the functions of the drive system ECU 31 may be implemented by another ECU (the preceding vehicle following control ECU 20, for example). Further, conversely, any part of or all of the functions of the preceding vehicle following control ECU 20 may be implemented by the drive system ECU 31.

The drive system ECU 31 controls the electronic throttle valve 41, the electric motor 42 and the transmission 43.

The electronic throttle valve 41 changes a throttle opening angle (throttle position) of the engine (not illustrated) according to an instruction from the drive system ECU 31.

The electric motor 42 is provided such that the electric motor 42 can transmit power to the wheels. The electric motor 42 generates the creep torque in response to the instruction (i.e., the target value of the creep torque) from the drive system ECU 31. For example, the drive system ECU 31 controls the electric motor 42 such that the target value of the creep torque instructed by the drive system ECU 31 is implemented. The control the electric motor 42 is implemented by controlling an inverter (not illustrated), for example.

The transmission 43 changes a transmission gear ratio according to the instruction from the drive system ECU 31. It is noted that the transmission 43 may include a clutch that changes a connection state between the electric motor 42 and the wheels according to the instruction from the drive system ECU 31.

The brake ECU 32 is connected to the brake actuator 44. The brake ECU 32 controls the brake actuator 44 based on demand deceleration G (described hereinafter) such that the demand deceleration G is implemented. It is noted that, in this example, the brake ECU 32 performs a brake hold control during the period in which the preceding vehicle following control is performed. The brake hold control is performed to generate a predetermined brake force (after a lapse of a predetermined second from the timing when the vehicle stop event is detected) during a period in which the vehicle is being stopped, for example. The predetermined brake force may be varied according to the demand deceleration G at that timing.

The preceding vehicle following control ECU 20 includes a target acceleration calculation part 21 and a travel state determination part 22.

During a period in which an autonomous drive switch (not illustrated) that is operated by a user is in its ON state, the target acceleration calculation part 21 determines, based on the preceding vehicle information from the radar 11, target acceleration/deceleration (demand acceleration/deceleration) G for an autonomous drive. At that time, the target acceleration calculation part 21 may calculate the demand acceleration/deceleration G based on the preceding vehicle information from the radar 11. It is noted that a way of calculating the demand acceleration/deceleration G is arbitrary. For example, the calculation way used in ACC (Adaptive Cruise Control) or the like may be used. For example, the demand acceleration/deceleration G may be determined such that an inter-vehicle distance between the preceding vehicle and the host vehicle becomes a predetermined target inter-vehicle distance, or an inter-vehicle time (=inter-vehicle distance/vehicle speed) between the preceding vehicle and the host vehicle becomes a predetermined target inter-vehicle time. In the latter case, the target inter-vehicle time may be set on a vehicle speed basis (vehicle speed of the host vehicle). Further, the target inter-vehicle time may be varied within a predetermined range set by the user. Further, if demand acceleration/deceleration of the preceding vehicle can be obtained via the inter-vehicle communication with the preceding vehicle, the demand acceleration/deceleration G may be calculated considering the demand acceleration/deceleration of the preceding vehicle. It is noted that, in the following, the negative demand acceleration/deceleration G is also referred to as “demand deceleration G”. Further, the demand deceleration G being small (i.e., the deceleration being small) means that an absolute value (magnitude) of the demand deceleration G is small.

The preceding vehicle following control ECU 20 performs the preceding vehicle following control over the whole vehicle speed range including 0, as described above. The target acceleration calculation part 21 calculates a small demand deceleration G in the low speed range. In other words, the target acceleration calculation part 21 sets the demand deceleration G immediately before the vehicle stops such that the demand deceleration G at a timing immediately before the vehicle stops is smaller than that at a timing that is before the timing immediately before the vehicle stops. It is noted that the timing immediately before the vehicle stops corresponds to any timing at which the vehicle speed is within a vehicle speed range which greater than 0 and less than a predetermined low speed value. With this arrangement, a shock at the time of the vehicle stop event can be reduced, which enables a smooth transition to the stopped state.

The travel state determination part 22 determines, based on the vehicle speed information from the vehicle wheel speed sensors 12, whether the vehicle is traveling. The travel state determination part 22 may use other information, in addition to or instead of the vehicle speed information from the vehicle wheel speed sensors 12, whether the vehicle is traveling. For example, other information may include a rotational rpm of an output shaft of the transmission, or a history of a calculation result of the vehicle position obtained from a GPS receiver. Further, the travel state determination part 22 determines, based on information (obtained from the brake ECU 32) about whether the brake hold control is being operated, whether the vehicle is traveling.

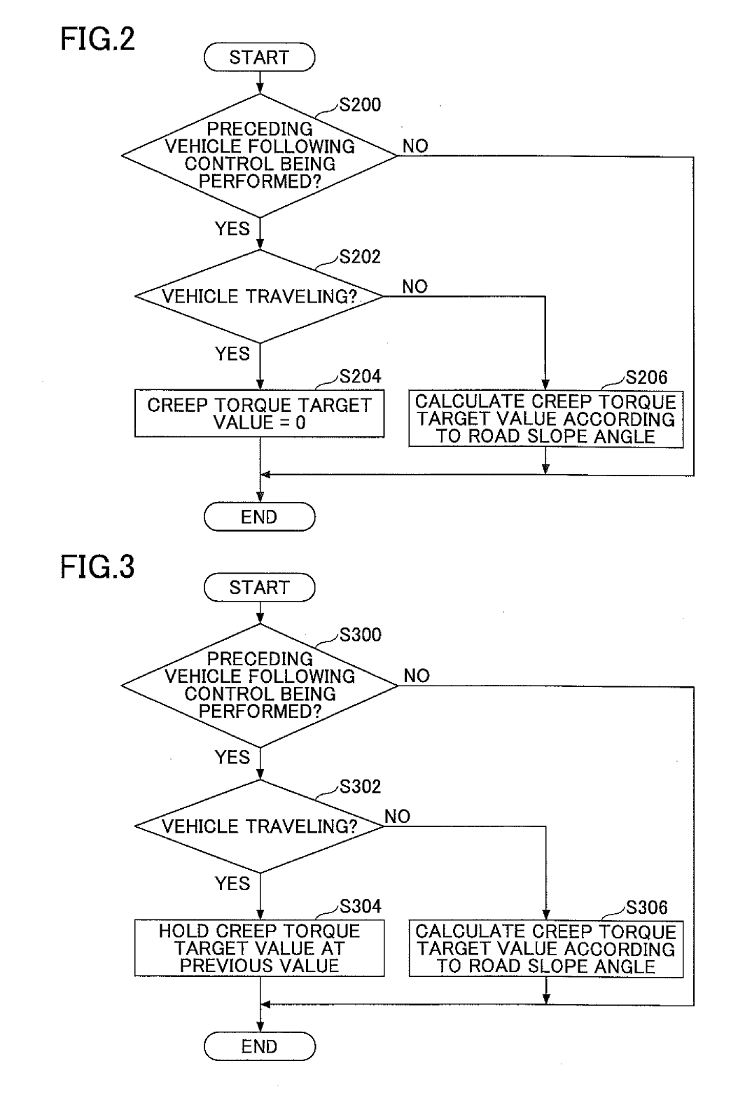

FIG. 2 is an example of a flowchart of a process executed by the vehicle control ECU 31. The process illustrated in FIG. 2 may be performed repeatedly at a predetermined cycle during the ON state of the autonomous drive switch.

In step S200, the drive system ECU 31 determines whether the preceding vehicle following control ECU 20 is performing the preceding vehicle following control. The drive system ECU 31 may determine, based on information from the preceding vehicle following control ECU 20, whether the preceding vehicle following control ECU 20 is performing the preceding vehicle following control. If it is determined that the preceding vehicle following control ECU 20 is performing the preceding vehicle following control, the process routine goes to step S202, otherwise the process routine at the current cycle directly ends.

In step S202, the drive system ECU 31 determines, based on the determination result from the travel state determination part 22, whether the vehicle is traveling. It is noted that the drive system ECU 31 may directly determine, based on the information from the brake ECU 32 or the vehicle speed information from the vehicle wheel speed sensors 12, whether the vehicle is traveling. If it is determined that the vehicle is traveling, the process routine goes to step S204, otherwise the process routine goes to step S206.

In step S204, the drive system ECU 31 retains the target value of the creep torque at 0 (an example of a predetermined value).

In step S206, the drive system ECU 31 sets, based on road slope angle information from the acceleration sensor 13, the target value of the creep torque according to the road slope angle. For example, the drive system ECU 31 may set the target value of the creep torque according to the road slope angle in terms of preventing the host vehicle from moving down an uphill slope or preventing a delay in a start of the host vehicle upon the pedal to be pressed being changed from a brake pedal to an accelerator pedal. In this case, the drive system ECU 31 sets the target value of the creep torque such that the target value of the creep torque increases as the road slope angle increases. During the stopped state of the vehicle, the target value of the creep torque may be set based on the road slope angle at the position (stopped position) of the vehicle, which can effectively reduce the probability of the occurrence of such inconvenience such as the vehicle moving down, etc., at the stopped position.

It is noted that when the drive system ECU 31 determines the target value of the creep torque in step S204 or step S206, the drive system ECU 31 controls the electric motor 42 such that the target value of the creep torque is implemented, and controls the electronic throttle valve 41, the electric motor 42 and the transmission 43 such that the demand acceleration/deceleration G is implemented. In this case, a control target value for the electric motor 42 may be generated by adding a control target value based on the target value of the creep torque to a control target value based on the demand acceleration/deceleration G.

According to the process illustrated in FIG. 2, the drive system ECU 31 retains the target value of the creep torque to be generated by the electric motor 42 at 0 (an example of a predetermined value) during the period in which the preceding vehicle following control is performed and the vehicle travels. With this arrangement, even if such an event occurs in which the demand deceleration G becomes small immediately before the vehicle stops during the period in which the preceding vehicle following control is performed, it is possible to prevent such an event from causing the creep torque to increase and thus reduce the deceleration. Thus, the feeling of deceleration immediately before the vehicle stops can be improved.

It is noted that, according to the process illustrated in FIG. 2, the target value of the creep torque is retained at 0 during the period in which the preceding vehicle following control is performed and the vehicle travels, regardless of the vehicle speed and the demand acceleration/deceleration G (i.e., regardless of whether the vehicle is accelerated, decelerated or travels at a constant speed). This is because there is no substantial inconvenience in a situation other than the situation immediately before the vehicle stops, as long as the target value of the creep torque is retained at 0 during the period in which the preceding vehicle following control is performed and the vehicle travels. However, during the period in which the preceding vehicle following control is performed and the vehicle travels, if a predetermined condition is met, the process routine may goes to step S204, otherwise goes to step S206. The predetermined condition may include the vehicle speed being less than or equal to a predetermined value, the vehicle being in the decelerated state, etc.

FIG. 3 is another example of a flowchart of the process executed by the drive system ECU 31. The process illustrated in FIG. 3 may be performed repeatedly at a predetermined cycle during the ON state of the autonomous drive switch.

The processes of step S300 and step S302 may be the same as those of step S200 and step S202 illustrated in FIG. 2, respectively.

In step S304, the drive system ECU 31 retains the target value of the creep torque at the previous value (an example of a predetermined value). Specifically, the drive system ECU 31 calculates the target value of the creep torque at the process cycle, and if the calculated value (referred to as “the value at this cycle” hereinafter) of the target value of the creep torque at the current cycle is less than or equal to the calculated value (referred to as “the previous value” hereinafter) at the previous cycle, retains the target value of the creep torque at the previous value, otherwise updates the target value of the creep torque with the value at this cycle. In other words, if the value at this cycle of the target value of the creep torque is less than or equal to the previous value, the drive system ECU 31 does not update the target value of the creep torque to retain it at the previous value, while if the value at this cycle of the target value of the creep torque is greater than the previous value, the drive system ECU 31 updates the target value of the creep torque with the value at this cycle. A way of calculating the target value of the creep torque (the value at this cycle) is arbitrary. For example, the drive system ECU 31 may set, based on the road slope angle information from the acceleration sensor 13, the vehicle speed information from the vehicle wheel speed sensors 12 and the demand acceleration/deceleration G from the preceding vehicle following control ECU 20, the target value of the creep torque according to the road slope angle, the vehicle speed and the demand acceleration/deceleration G. In this case, the target value of the creep torque may be set such that the target value of the creep torque increases as the road slope angle increases. Further, the target value of the creep torque may be set such that the target value of the creep torque decreases as the vehicle speed increases. For example, the target value of the creep torque may be set to 0 if the vehicle speed is high (out of the low speed range, for example), while the target value of the creep torque may be set such that the target value is greater than 0 if the vehicle speed is low. Further, the target value of the creep torque may be set such that the target value of the creep torque decreases as the demand acceleration/deceleration G increases in a deceleration direction. For example, if the demand acceleration/deceleration corresponds to the demand deceleration G whose magnitude is greater than or equal to a predetermined value, the target value of the creep torque may be set to 0, otherwise the creep torque may be set such that the target value is greater than 0. It is noted that the target value of the creep torque may be limited not to exceed a predetermined upper limit value (maximum value). In this case, once the target value of the creep torque increases to the upper limit value during the period in which the vehicle travels, the target value of the creep torque is retained at the upper limit value until the vehicle stops.

In step S306, the drive system ECU 31 sets, based on the road slope angle information from the acceleration sensor 13, the target value of the creep torque according to the road slope angle. A way of calculating the target value of the creep torque according to the road slope angle may be the same as described above with reference to step S206. During the stopped state of the vehicle, the target value of the creep torque may be set based on the road slope angle at the position (stopped position) of the vehicle, which can effectively reduce the probability of the occurrence of such inconvenience that the vehicle moves down, etc., from the stopped position.

According to the process illustrated in FIG. 3, the drive system ECU 31 retains the target value of the creep torque to be generated by the electric motor 42 at the previous value (an example of a predetermined value) during the period in which the preceding vehicle following control is performed and the vehicle travels. With this arrangement, the reduction in the target value of the creep torque is suppressed during the period in which the preceding vehicle following control is performed and the host vehicle travels. With this arrangement, even if such an event occurs in which the demand deceleration G becomes small immediately before the vehicle stops during the period in which the preceding vehicle following control is performed, it is possible to prevent such an event from causing the creep torque to increase and thus reduce the deceleration. Thus, the feeling of deceleration immediately before the vehicle stops can be improved.

It is noted that, according to the process illustrated in FIG. 3, the target value of the creep torque is retained at the previous value during the period in which the preceding vehicle following control is performed and the vehicle travels, regardless of the vehicle speed and the demand acceleration/deceleration G (i.e., regardless of whether the vehicle is accelerated, decelerated or travels at constant speed). This is because, although it depends on the way of calculating the target value of the creep torque, in general, with respect to the target value of the creep torque calculated immediately before the vehicle stops, the value at this cycle is not greater than the previous value, which causes the target value of the creep torque to be retained at the constant value. Further, this is because there is no substantial inconvenience in a situation other than the situation immediately before the vehicle stops, as long as the target value of the creep torque is retained at the previous value during the period in which the preceding vehicle following control is performed and the vehicle travels. However, during the period in which the preceding vehicle following control is performed and the vehicle travels, if a predetermined condition: is met, the process routine may go to step S304, otherwise goes to step S306. The predetermined condition may include the vehicle speed being less than or equal to a predetermined value, the vehicle being in the decelerated state, etc.

Further, according to the process illustrated in FIG. 3, in step S304, if the value at this cycle of the target value of the creep torque is less than or equal to the previous value, the drive system ECU 31 retains the target value of the creep torque at the previous value, while if the value at this cycle of the target value of the creep torque is greater than the previous value, the drive system ECU 31 updates the target value of the creep torque with the value at this cycle. However, in step S304, the drive system ECU 31 may always retain the target value of the creep torque at the previous value (regardless of the relationship between the value at this cycle and the previous value.

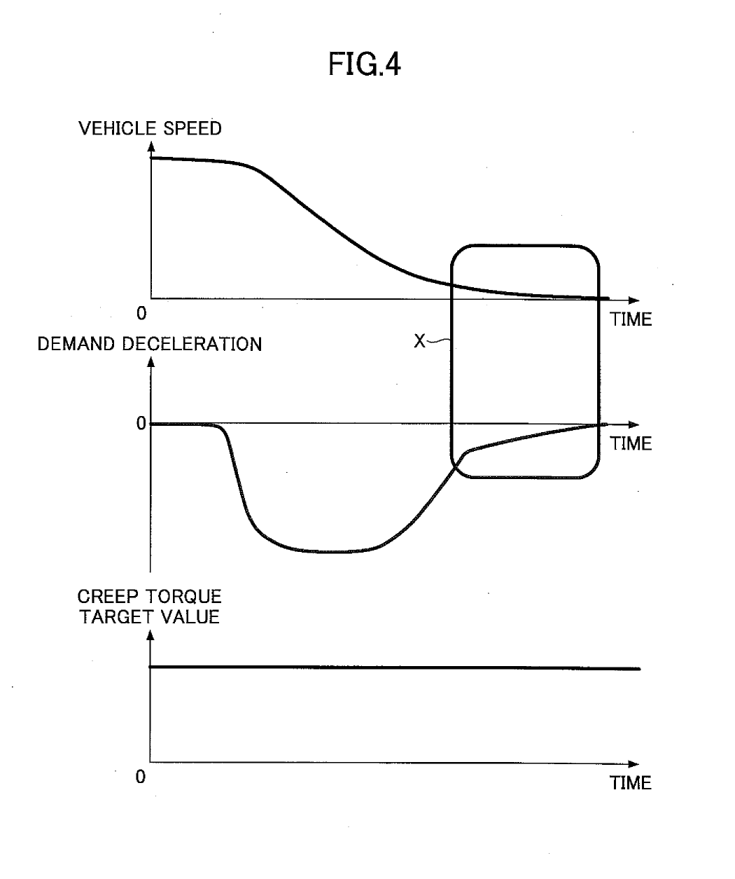

FIG. 4 is a diagram explaining a process illustrated in FIG. 3, and illustrates time series of respective parameters until the vehicle stops. Specifically, in FIG. 4, from the upper side, the first time series is related to the vehicle speed, the second time series is related to the demand deceleration G, and the third time series is related to the target value of the creep torque.

The demand deceleration G calculated by the target acceleration calculation part 21 has the small magnitude in the low speed range for the sake of reducing the shock at the time of the vehicle stop event, as described above. Thus, as illustrated in FIG. 4, the demand deceleration G becomes smaller immediately before the vehicle stops (see a section X in FIG. 4). Further, in the example illustrated in FIG. 4, a state in which the value at this cycle of the target value of the creep torque is less than or equal to the previous value continues immediately before the vehicle stops, and thus the target value of the creep torque is retained at a constant value. With this arrangement, as illustrated in FIG. 4, the creep torque is not changed even if the demand deceleration G becomes smaller immediately before the vehicle stops, and thus the vehicle speed is smoothly reduced to 0. Therefore, the feeling of deceleration immediately before the vehicle stops can be improved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention. Further, all or part of the components of the embodiments described above can be combined.

For example, according to the embodiments described above, the preceding vehicle following control ECU 20 sets the target acceleration to adjust the inter-vehicle parameter during the period in which the preceding vehicle following control is performed; however, the preceding vehicle following control ECU 20 may sets a target speed to adjust the inter-vehicle parameter.

Further, according to the embodiments described above, the preceding vehicle following control ECU 20 performs the preceding vehicle following control over the whole vehicle speed range including 0; however, the preceding vehicle following control ECU 20 may not perform the preceding vehicle following control if the vehicle speed exceeds a predetermined vehicle speed.

The present application is based on Japanese Priority Application No. 2014-146225, filed on Jul. 16, 2014, the entire contents of which are hereby incorporated by reference.

What is claimed is:

1. A vehicle travel control apparatus, comprising:
an electric motor that generates a creep torque;
a preceding vehicle following control part that performs a preceding vehicle following control for adjusting an inter-vehicle distance between a preceding vehicle and a host vehicle based on a travel state of the preceding vehicle, the preceding vehicle following control being continued until the host vehicle transitions to a stopped state; and
a creep torque control part that controls a creep torque control, wherein the creep torque control part retains a target value of the creep torque to be generated by the electric motor at a predetermined value during a period in which the preceding vehicle following control is performed and the host vehicle travels.

2. The vehicle travel control apparatus of claim 1, wherein the predetermined value is 0.

3. The vehicle travel control apparatus of claim 1, wherein, during the period in which the preceding vehicle following control is performed and the host vehicle travels, the creep torque control part calculates the target value of the creep torque at a predetermined cycle, retains the target value of a previous cycle if the target value calculated in a current cycle is less than or equal to the target value calculated in the previous cycle, and otherwise updates the target value with the target value calculated in the current cycle.

4. The vehicle travel control apparatus of claim 1, wherein the creep torque control part sets the target value of the creep torque based on a road slope angle at a position of the vehicle during a period in which the host vehicle is stopped.

5. The vehicle travel control apparatus of claim 1, wherein, during the period in which the preceding vehicle following control is performed, the preceding vehicle following control part sets a target acceleration at a first timing that is immediately before the vehicle is stopped such that the target acceleration at the first timing is less than the target acceleration at a second timing that is before the first timing.
